(19) United States
(12) Patent Application Publication
(10) Pub. No.: US 2012/0089057 A1
(43) Pub. Date: Apr. 12, 2012

(54) FREQUENCY THERAPY METHOD AND DELIVERY SYSTEM

(76) Inventor: GERT ELFERING, LONDON (GB)

(21) Appl. No.: 13/271,271

(22) Filed: Oct. 12, 2011

Related U.S. Application Data
(60) Provisional application No. 61/392,317, filed on Oct. 12, 2010.

(51) Int. Cl. A61H 1/00

(52) U.S. Cl. 601/47

(57) ABSTRACT

In a therapy method, the oscillations/vibrations of a natural substance or plant are first measured. Environmental signals are canceled out to isolate only a useful signal. The useful signal is then amplified and stores in a sound file library containing a many such useful signals. An audio file is generated by mixing from one or more useful signal files from the sound file library and the audio file is then delivered to a subject. The delivery may be effected by direct sound playback, via the tympanic membrane or the skin of the user, or by exposing a carrier medium, such as water or cream or oil, to the mixed file and then applying the carrier medium to the subject.

### CROSS-REFERENCE TO RELATED APPLICATION

This application claims the benefit, under 35 U.S.C. §119(e), of provisional patent application No. 61/392,317, filed Oct. 12, 2010; the prior application is herewith incorporated in its entirety.

### BACKGROUND OF THE INVENTION

### Field of the Invention

The invention relates to a therapeutic method and system. The frequency therapy of the invention is based on complementary and alternative medicine (“CAM”), especially traditional Chinese medicine (“TCM”) combined with homeopathy as well as modern quantum mechanics and nanotechnology. The invention utilizes the physics law of conservation of information.

It would be well beyond this specification to deal with the specifics of the law of conservation of information. Whether it be founded in quantum mechanics, in Hawking's solution of the black hole information paradox, in classical wave theory, or in a rigorous description of string theory, the following specification assumes as correct and applicable that information is contained in many systems, is retained in all physical states of the system, and is transferable from one state to another and from one matter to another.

Each human cell consists of two dimensions: the DNA (i.e., akin to hardware) and the vacuum (i.e., akin to software). The vacuum is an energy field that holds information that steers the construction and function of our cells. It is responsible for the determination which part of the DNA is being read and used. The information may be expressed in the frequency domain and, as such, the frequencies envisioned and utilized in the novel system are targeted towards the information held in the energy field of the vacuum.

The cell loses its natural energetic state through aging, toxic environmental influences and destructive living conditions. Therefore, the effectiveness of the cell is damaged. If more cells of a system are getting damaged leading to an unnatural balance of more impaired than healthy cells, the entire system enters the stage of illness or oldness. In consequence, it would be desirable to be enabled to restore the natural information of the cell vacuum. This process is akin to reprogramming the cell.

### BRIEF SUMMARY OF THE INVENTION

It is accordingly an object of the invention to provide a method and a system, which provides for a solution to the above-mentioned quandary and which makes it possible to regenerate lost information and to restore cells and living organisms to their natural, and healthy, state.

With the foregoing and other objects in view there is provided, in accordance with the invention, a therapy method, which comprises:

recording a first input signal generated by a natural substance or plant at a first location, the first input signal being a composite of a useful signal originating from the natural substance or plant and a nuisance signal;

recording a second input signal in close vicinity of the first location, the second input signal substantially only containing the nuisance signal;

processing the first and second input signals to thereby isolate the useful signal from the composite signal while canceling the nuisance signal;

amplifying the useful signal and storing the useful signal in a sound file library containing a plurality of useful signals;

generating an audio file from one or more useful signals by mixing one or more useful signals from the sound file library; and

delivering the audio file to a subject.

In accordance with an added feature of the invention, the processing step comprises inverting the second input signal and combining the first input signal with the inverted second input signal.

In accordance with an additional feature of the invention, the recording step comprises recording sound waves emanating from the natural substance or plant, and wherein the nuisance signal is an environmental sound signal.

In accordance with another feature of the invention, the delivering step comprises playing back the audio file and exposing the subject to sound generated by the audio file. The delivery may be by playing back the audio file with an MP3 player through head phones. It is also possible to play the audio file to a carrier medium (e.g., water, oil, cream, lotion, etc.), and exposing the subject to the carrier medium. In the alternative, it is possible to deliver the file to the subject by placing a plate onto the skin of the subject and exciting the plate to oscillation with the signals of the audio file

In accordance with an added feature of the invention, the method comprises: recording and processing a multitude of useful signals originating from a multiplicity of natural substances and plants, transforming and storing the useful signals in a frequency library, selecting from the library a plurality of file, formulating and mixing from the plurality of files mixed resonant frequency bundles combining a plurality of different frequencies through enforcement, sequences, and overlay, and delivering individual frequency bundles to the subject.

The novel process, which we refer to a the “eWaves” method, aims to produce correspondent frequencies that are able to increase the intrinsic energy of the impaired cell up to its original state. Each cell has a memory of its healthy energetic stage and therefore, knows which information is needed to repair itself. The eWaves frequency therapy stimulates the natural self healing and rejuvenating ability of the human body.

The frequencies that are used by the eWaves method are created from natural substances and therefore, produce the strongest resonance. Resonances occur when a system is able to store and transfer easily energy between two or more different storage modes. The frequencies show no side effects because the cell only absorbs its missing information. Unnecessary, unused frequencies are passing through the cell and show no effect. Synthetic frequencies are assumed to not be healthy for the body.

In accordance with the invention, we provide for a transformer. The eWaves transformer that we have used, has read the frequencies of thousands of natural substances and transformed them into a frequency library. From this computer based library, our specialists (pharmacists) have mixed resonant frequency bundles (formulas) that combine several different frequencies through enforcement, sequences and overlay. The perfect frequency bundle would be the 100% reproduction of the frequency of the healthy cell.

The eWaves frequency bundles are as close as possible to the natural energetic stage of the cell and therefore hold the correct information to reprogram the vacuum of the impaired cell. The energy passes through the cell membrane to the binding proteins of the DNA. The cell restores its natural resonance by absorbing the missing information that oscillates the cell energy to its original maximum. The improved proteins lead to the repair of the cell structure. In the context of this invention, we call these resonant frequency bundles “Vita Waves.”

The Vita Waves may be delivered in different carriers so that they reach the cell in different modes: as sound waves (e.g. Internet streaming, MP3-player, etc.) or through liquid (water, oil, serum and cream).

Other features which are considered as characteristic for the invention are set forth in the appended claims.

Although the invention is illustrated and described herein as embodied in a frequency therapy method and delivery system, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE SEVERAL VIEWS OF THE DRAWING

FIG. 1 is an illustration of the cancellation, i.e., the mutual extinction of sound waves;

FIG. 2 is an illustration of the regeneration of the useful signal by subtraction of an interference signal;

FIG. 3 is a circuit diagram of an exemplary device according to the invention for acquiring and processing useful signals for transmission to a frequency library;

FIG. 4 is a graph showing a short segment of a useful signal;

FIG. 5 is a signal graph illustrating a useful signal that is looped several times; and

FIG. 6 is a graph showing signal volume ratios of various individual signals and a composite signal relative to a number of tracks.

### DETAILED DESCRIPTION OF AN EXEMPLARY EMBODIMENT

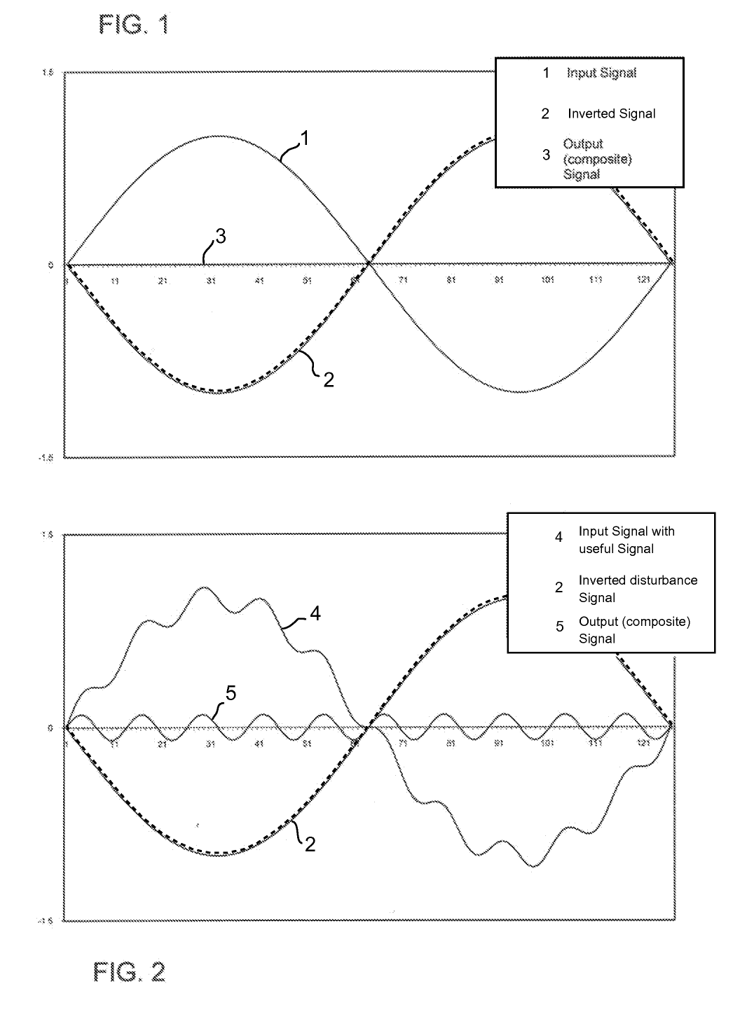

Referring now to the figures of the drawing in detail and first, in particular, to FIGS. 1 and 2 thereof, there is shown a principle of sound cancellation and of signal subtraction. Sound waves are longitudinal pressure waves. A pressure wave may be cancelled by an equal and opposite pressure wave. In the idealized graph of FIG. 1, for instance, a sinusoidal input signal 1 may be opposed by an inverted signal 2, here the exact same signal with an opposite phase. A composite signal 3, therefore is exactly a flatline signal. The indicated amplitude units on the abscissa are arbitrary.

In FIG. 2, the sinusoidal input signal 4 forms a carrier of a useful signal, which is modulated onto the carrier signal. Here, too, the useful signal is indicated as a sinusoidal signal with a frequency that is a multiple of the carrier signal frequency. The same inverted signal 2 as in FIG. 1 is used here to cancel the carrier signal 4. The leftover signal 5 which is illustrated along the center line corresponds to the useful signal that is modulated onto the carrier. That is, the useful signal has been extracted from the carrier by offset-cancelling the carrier signal.

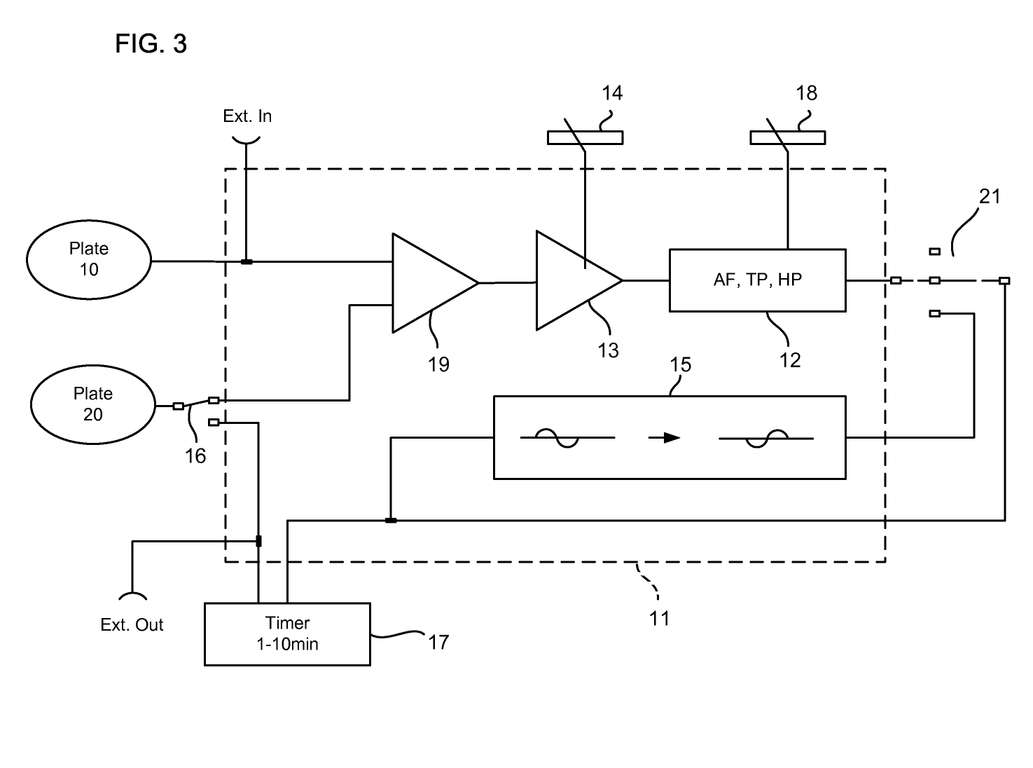

Referring now to the remaining figures and, particularly, to FIG. 3, the first part of the novel system concerns the acquisition of the information, i.e., the reading in of the frequency oscillations and the acceptance (approval) of information. Certain functions and certain equipment are required.

The read-in unit is a device, which records oscillations (i.e., frequencies) that are delivered in the form of electrical oscillation signals at two inputs (medium to be read-in and interference signals and ambient signals), processes them and provides them in processed form for recordation at the output.

The device consists of a base plate with two adjacent metal surfaces (if necessary, two shielded cups of the same construction as an expansion), the central unit and the cap. The base plate and the central unit are connected by way of a plug.

The base plate consists of two metal plates, of which one is used for piecing with a specimen. Plate 10 is used as the input for the useful signal. An additional plate 20 records (i.e., absorbs) the interference effects of the environment in order to subtract them from the input signal, if necessary. This procedure allows the pure, useful signal to be filtered out, according to the principle illustrated in FIG. 2. The plate 20 can also function as an additional output (transfer of information onto the carrier). The central unit 11 contains the electronics and the operator elements.

Those sections of the input wave spectrum, which are to be transferred to the output (switch AF/TP/HP), are adjustable. Thus, it is possible to pass
only the high frequencies
only the low frequencies
the entire spectrum of frequencies
   on to the output. The frequency selection is effected in a frequency filter 12. The filter 12 is adjustable by way of an external selection switch 18. The filter is fully adjustable, but the set filters TP and HP offer a further possibility for correction. TP only allows frequencies below 1000 Hz (1000 oscillations per second) to pass to the output, HP only frequencies above 1000 Hz. Thus, HP filters out, for example, the disrupting 60 Hz oscillations of the mains power supply.

The amplification of the input signal and the duration of the transfer are also controllable. The amplification is effected by an amplifier 13 which is operator-adjustable with external switch 14. The amplification may be sixty times that of the input signal.

Finally, it is possible for the operator to select whether the input signal is directly transferred onto the output or inverted in an inverter 15. This means that the incoming wave may be reversed (positive deflection is converted into a negative one and vice versa, while the waveform is maintained). The transfer is triggered by (initiated with) the start key.

The connection for the power switch, four outputs, two inputs (external read-in cup), one additional output with two-fold amplification and an IN differential switch are located on the backside.

The inputs are connected with the plate 10 and the plate 20. The connection is effected by a plug, which connects the base plate and the central unit 11 with one another.

An IN differential switch 16 connects the plate 20 with the electronics, which, again, subtracts the signal emitted by the plate 20 (cup 20) from the one emitted by the plate 10 (cup 10) or switches the plate 20 as the output. The difference formation is illustrated as an op-amp 19 into which the signals from the plate 10 and the plate 20 are fed.

Due to the fact that we deal here with very highly sensitive systems, all cables which guide signals are shielded, which means, enclosed by a metal net located on a mass, which net prevents electrical interference effects (among others, from the power switch). The shieldings must be configured neatly up to the connections, so that all cables guiding signals are shielded from possible, disrupting electrical influences. It should be understood that any noise would typically be a disturbance and that a superior signal-to-noise ratio is desirable.

The metal plates of the base plate are connected directly with the plug by means of a shielded cable with the plug being placed onto the central unit, and receive a mass connection as an opposite pole.

Besides the display of the built-in timer, the electronics controls the amplification and the difference formation “input−plate 20” and the frequency filtering.

The duration of the signal transfer is adjusted to be between 1 and 10 minutes by way of the timer 17. Electrical waves (frequencies) present on the metal plate 10 or on the two input sockets, are transmitted, in a timer-controlled manner, to the four output sockets (jacks) for an adjustable period of 1-10 minutes. Longer or shorter times are possible as well.

In order to correct the input signal, the signal present on the metal plate 20 is subtracted from the former by means of the IN differential switch 16. If the same signal is present on the metal plate 10 and 20, no output signal is present when the IN differential switch is on.

The input signal is either processed by means of the mentioned possibilities and directly guided to the outputs or inverted when adjusted correspondingly. If one were to mix the input signal, when uncorrected and unamplified, with the inverted output signal, the signals would cancel each other.

The power supply for supplying current is a power supply that is approved for medical equipment. The power supply typically delivers a direct current d.c. voltage of 15V at the output.

The base plate consists of two metal plates, which are each connected with the connection plug for the central unit via a shielded cable. The input (plate 10/cup 10) and the plate 20/cup 20 are switched to the differential amplifier 19 (for example, BB INA 105U), which subtracts the signals from one another. A preferred connection layout of the plug is as follows: Lead 8: signal plate 10 (input), lead 15: shielding cable plate 10; lead 5: signal plate 20 (differential input); and lead 12: shielding cable plate 20.

In an exemplary embodiment of the system the central unit 11 is provided with a main board with the electronics for signal mixing, signal amplification, signal filtering and signal inversion, connections of the exterior operator elements, a switch for the timer (1-10 min) and the drive of the ten time signal-LEDs, a drive of the remaining LEDs, connections for the base plate and an additional plug at the upper side of the device for additional devices, and terminal connections of the inputs and outputs.

In the ON position, the IN differential switch 16 connects the metal plate 20 with the differential amplifier 19, which forms the difference of the input signal and the signal of the plate 20 as well as the appertaining front LED with the supply voltage. In the OFF position of the switch 16, the plate 20 is switched as an additional output.

The signals may be delivered from the central unit 11 for storage. For that purpose, the absorbed (received) individual frequencies (frequency patterns) are present as an analog signal at the output (EXTERNAL OUT) 21.

In this case, the wavelength (s) is between 2.00E+02 and 4.00E−06/the frequencies at the output lie between 0.005 and 250,000 Hz. The amplitude (V) of the signal is at 10V to 3V.

The output signals, carrying the transferred oscillation patterns, are deposited as digital data in a database that is controlled by a computer program. The analog-to-digital conversion of the analog output signal is effected at a suitable scanning frequency, which must be above the Nyquist rate for the highest frequency useful signal.

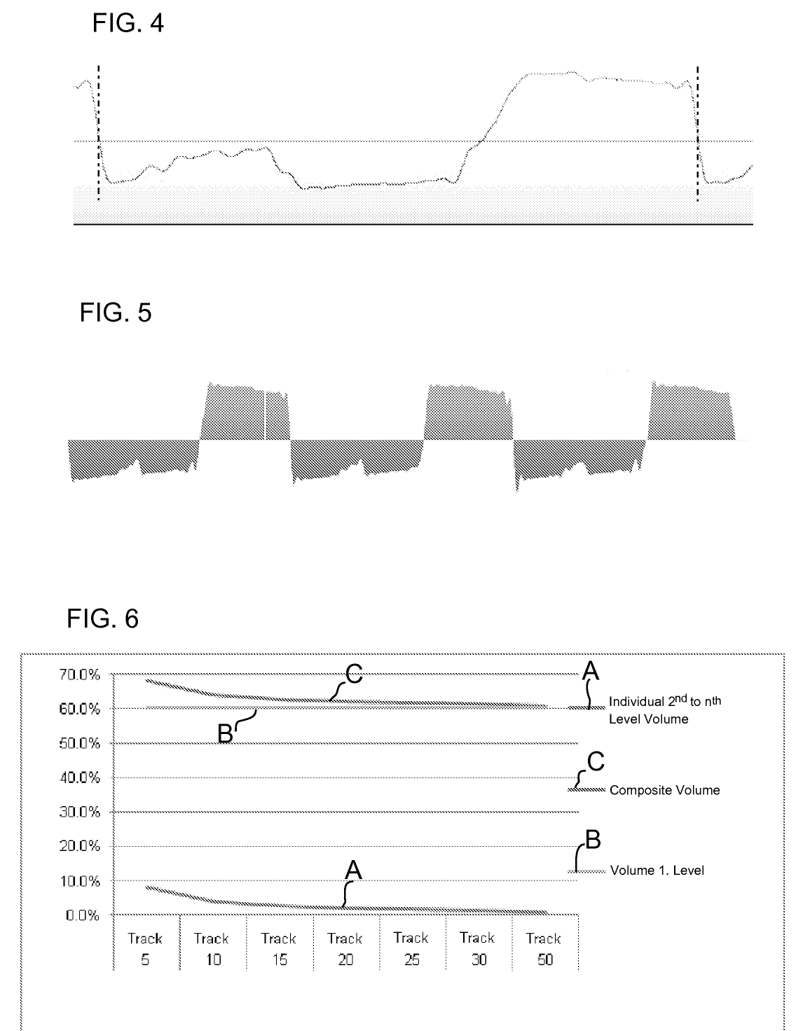

We now turn to the subsequent processing of the recorded frequency patterns and make reference to FIG. 4 et seq. The recorded, digital sound patterns (recorded output sound lasting approximately 60-180 seconds) show a clear pattern, wherein the repetitions (loops) of the individual frequency patterns are recognizable. The average length of an individual frequency pattern is between 0.3 and 1.0 seconds.

The pattern illustrated in FIG. 4, with the individual frequency patterns (more precisely, approximately 3 repetitions) is cut out of the digital sound pattern (the output sound) and subsequently processed by way of a sound program.

During subsequent processing, the individual frequency patterns (length between 0.3 to 1 seconds) are cut so that the time of commencement and the finite time are present on the acoustic zero line. On the one hand, this corrects the transfer between the frequency patterns now to be looped to one another and, on the other hand, the subsequently necessary transfer of the individual sounds, resulting therefrom, of the read-in information (crackling/clicking). This processing step clearly improves the product convenience and serves the necessary relaxation of the user.

The corrected, individual frequency patterns of FIG. 4 are cut off at the vertical lines and looped, as in FIG. 6, to a length of approximately 3 seconds and stored as a sound file in .wav format in a database.

The setup and formulation of a treatment process are as follows: First, we deal with the arrangement of individual frequencies. According to the created mixture prescription the looped, individual frequency patterns are compiled in a sound file. In this case, the respective sequences of 3 seconds are arranged in two planes in several sound tracks, which corresponds to the number of components+1.

In a first plane (i.e., track 1), all individual frequency patterns are presented in succession. In a second plane (i.e., tracks 2 to n), the respective, individual frequency patterns are looped separately one after the other over the entire run time of the treatment.

Thus, the separate, individual frequencies of the components are played, in each case, simultaneously (second plane/track 2 to n) and additionally, separately (first plane/first track).

This doubles and highlights all frequencies successively. The doubling is represented in the following table:

| | Block 1 | Block 2 | Block 3 | Block 4 |
|---|---|---|---|---|
| Track 1 | Ing. 1 | Ing. 2 | Ing. 3 | Ing. 4 |
| Track 2/Ing. 1 | Ing. 1 | Ing. 1 | Ing. 1 | Ing. 1 |
| Track 3/Ing. 2 | Ing. 2 | Ing. 2 | Ing. 2 | Ing. 2 |
| Track 4/Ing. 3 | Ing. 3 | Ing. 3 | Ing. 3 | Ing. 3 |
| Track 5/Ing. 4 | Ing. 4 | Ing. 4 | Ing. 4 | Ing. 4 |

The volume of the individual tracks is centrally important. The number of the used frequencies has a direct effect on the volume of the individual tracks of the second planes (track 2-n). By way of efficiency tests, we were able to determine that an optimal ratio of the first and second plane amounts to 60:40 (volume of the first plane).

Taking this ratio as the basis, the individual volume of the second plane (the respective track 2 to n) is defined via the number of the used, individual frequency patterns.

This also changes the ratio in which the individual frequency patterns are highlighted as the composite volume because of the doubling with the first plane (and are thus highlighted).

With reference to FIG. 6, given five tracks (components), the individual frequency pattern is highlighted by 8% because of the doubling, however, only by 0.8% given 50 tracks. This also results in a limit (maximum number) of individual frequency patterns that can be combined with one another.

With regard to the formulation, product ideas are developed within the context of client feedback (inquiries about products) and proposals by experts. In this case, specifically with regard to the expert proposals, the formulation may be directly responsive to the feedback received from these daily practices. Generally, all formulations are based primarily on formulations and means used in homeopathy.

Taking the desired properties of the product as the basis (contrary thereto described as symptoms in homeopathy), first formulations are composed, which are then supplemented, if necessary, by components of TCM, Ayurveda and naturopathy (e.g., Bach flowers, Bach flower extracts, Schuessler cell salts, or cell salts).

In a first step, these formulations are composed to test treatments, which, according to product, are additionally divided in cluster or sub-products (female/male, adults/children and juveniles). These test treatments are then tested in cumulative steps.

A first test step is a limited application test with test persons: In this first step, the treatments are tested by a small number (10-30) of test persons. The numeric feedback delivered in this case is evaluated according to the desired and defined properties.

If previously defined quality KPIs and efficiency KPIs are achieved, the product is transferred to the second test step.

A second test step is an application test by physicians/multipliers (professional test/supervised test):

TABLE II
schematic representation of the second test step: professional test

| | |
|---|---|
| Conversation with | 1. recordation of the master data of the test person |
| test subject | 2. definition of the individual test contents and the |
| | application parameters of the professional tester |
| | 3. assessment of the personal condition at the beginning |
| | of the application and self-assessment of the test person |
| | regarding aches and pains by speaking directly with the |
| | professional tester |
| | 4. systematic recordation of the physical condition based |
| | upon details provided by the test person (basis for |
| | determining criteria of influence and exclusion of |
| | individual products/e-waves method) |
| | 5. details on personal views and expectations of the test |
| | person (acquisition and basis for evaluating how views |
| | influence the success of the treatment) |
| feedback by | continuous feedback by the test person (evaluation of the |
| the test subject | respective preceding application) on: |
| | how the last application effected the impairment |
| | when improvement occurred |
| | 3. the type and individual evaluation of side effects |
| | observed during the application |
| | final feedback at the end of the test period on: |
| | how the application effected the impairment |
| | when and for how long the impairment improved |
| | 3. the type and the individual evaluation of all side |
| | effects which occurred and were observed during |
| | application |

Besides the numeric self-assessment on the period of application by the test person and the professional supervision, observation by physicians, multipliers (professional tester), the pulse-frequency analysis can also be used for evaluating medical products.

Even in this step, the achievement of set KPI's (quantitative and qualitative effect evaluation) is a prerequisite for the transfer to the product status.

Principally, the quality of a treatment is defined on two levels of the achieved efficiency: A “qualitative efficiency” defines the effect observed by the individual test person and/or multiplier with reference to the application objective, and in addition, with reference to the temporal profile and the achieved lasting effects. A “quantitative efficiency” defines the qualitative effect observed by the totality with reference to the defined application objective

The achieved efficiency is decisive on both levels as an indicator for the quality of a treatment, since the products are not individualized, thus applications are not tailored to the personal indicators of the user but must be effective as broadband products for a plurality of users.

The delivery of the therapy sound may be effected by a simple sound delivery system, by way of a kit or by delivery over the Internet. For instance, a sound file may be downloaded onto a portable player (e.g., iPod, Nano, etc.) or it may be sold as a complete kit (player with earphones).

In the alternative, the therapy sound file may also be transferred to an alternative carrier, by exposing the carrier medium (water, cream, oil, etc.) to the sound waves. In this type of delivery, where a liquid forms the carrier medium, the law of the conservation of information, known from physics, is utilized. The delivery may be effected as a transdermal delivery or as subcutaneous absorption.

In a further embodiment of the delivery, which may be seen as a hybrid, the sound file may be delivered to a plate or platelet (e.g., a metal plate or a composite metal/plastic plate) so as to induce a vibration in the plate. The plate is placed onto the skin of the user—any location may be chosen by the user—and the plate is excited to vibrate and thus “communicate” its vibration content through the skin and into the patient. One compact possibility here is a watch or a bracelet with a watch-like device that contains a complete electronics set. The backwall of the “watch” thus is formed as an oscillating platelet.

1. A therapy method, which comprises:
recording a first input signal generated by a natural substance or plant at a first location, the first input signal being a composite of a useful signal originating from the natural substance or plant and a nuisance signal;
recording a second input signal in close vicinity of the first location, the second input signal substantially only containing the nuisance signal;
processing the first and second input signals to thereby isolate the useful signal from the composite signal while canceling the nuisance signal;
amplifying the useful signal and storing the useful signal in a sound file library containing a plurality of useful signals;
generating an audio file from one or more useful signals by mixing one or more useful signals from the sound file library; and
delivering the audio file to a subject.

2. The therapy method according to claim 1, wherein the processing step comprises inverting the second input signal and combining the first input signal with the inverted second input signal.

3. The therapy method according to claim 1, wherein the recording step comprises recording sound waves emanating from the natural substance or plant, and wherein the nuisance signal is an environmental sound signal.

4. The therapy method according to claim 1, wherein the delivering step comprises playing back the audio file and exposing the subject to sound generated by the audio file.

5. The therapy method according to claim 4, which comprises playing back the audio file with an MP3 player through head phones.

6. The therapy method according to claim 4, wherein the delivering step comprises placing a plate onto the skin of the subject and exciting the plate to oscillation with the signals of the audio file.

7. The therapy method according to claim 1, wherein the delivering step comprises playing the audio file to generate sound waves, injecting the sound waves into a carrier medium selected from the group consisting of water, oil, cream, serum, and lotion, and exposing the subject to the carrier medium.

8. The therapy method according to claim 1, which comprises recording and processing a multitude of useful signals originating from a multiplicity of natural substances and plants, transforming and storing the useful signals in a frequency library, selecting from the library a plurality of file, formulating and mixing from the plurality of files mixed resonant frequency bundles combining a plurality of different frequencies through enforcement, sequences, and overlay, and delivering individual frequency bundles to the subject.
